(19) United States
(12) Patent Application Publication
(10) Pub. No.: US 2021/0378219 A1
(43) Pub. Date: Dec. 9, 2021

(54) ANTARCTIC KRILL TRAWL WITH CENTRALIZED SINKER AND SELF-EXPANDABLE MOUTH STRUCTURE

(71) Applicant: East China Sea Fisheries Research Institute, Chinese Academy of Fishery Sciences, Shanghai (CN)

(72) Inventors: Hongliang HUANG, Shanghai (CN); Lingzhi LI, Shanghai (CN); Jian LIU, Shanghai (CN); Jialiang YANG, Shanghai (CN); Xin RAO, Shanghai (CN)

(21) Appl. No.: 17/177,267

(22) Filed: Feb. 17, 2021

(30) Foreign Application Priority Data
Jun. 5, 2020 (CN) 202010503996.3

(51) Int. Cl. A01K 73/04; A01K 75/06

(52) U.S. Cl. CPC A01K 73/04; A01K 75/06

(57) ABSTRACT

It is provided an Antarctic Krill trawl with a centralized sinker and a self-expandable mouth structure, including a beam, an upper border rope, a lower border rope, a lateral line, a cover net, a flank net and a body net. A length of the beam is 18 to 20 meters. The beam enables the mouth to be expanded horizontally, a sinker is provided at each of two sides of a belly net at a front end of a first mouth of the body net. A component force of a sinking force by the sinker is transmitted through the lateral line and a sewing edge so as to cause the lower border rope in a tensioning state due to the transmitted force. The body net comprises a back net, a lateral net and a belly net. Taper ratios of the back net and the lateral net are 2-1.

### CROSS REFERENCE TO RELATED DISCLOSURE

This disclosure claims the priority of Chinese Patent Disclosure No. 202010503996.3, entitled “SELF-EXPANDABLE MOUTH STRUCTURE OF ANTARCTIC KRILL TRAWL WITH CENTRALIZED SINKER” filed with the Chinese Patent Office on Jun. 5, 2020, which is incorporated herein by reference in its entirety.

### TECHNICAL FIELD

The present disclosure relates to a trawl fishing gear for marine fishery, and in particular to a trawl fishing gear for Antarctic Krill (Euphausia superba) fishing.

### BACKGROUND ART

Since commercial development of Antarctic Krill resources in the 1980s, although a variety of operation modes such as trawl, purse seine and seiner-trawler have been tried, at present only one of them, namely trawl fishing, has been retained after many years of production practice.

When categorizing according to expansion modes of an Antarctic Krill trawl fishing gear, there are mainly two categories: one is to maintain horizontal expansion of a netting gear through a trawl otter board; the other is to maintain horizontal expansion of a netting gear through a beam at the front end of a trawl mouth. Regarding operation mode of otter trawl fishing, as an otter board may be maintained stably in a certain dynamic condition, each catch can be obtained through a complete process of casting, fishing and hauling. Furthermore, in order to expand the netting gear and the otter board fully, a warp, an otter board, a sweep line, an upper line, a float line, a lower line, a footrope, a lateral line, a cross line and the like need to be provided on the left side and the right side so as to ensure that the trawl fishing gear may be in a good operation condition. As there are a lot of components involved in connection between a ship and a net, causing a far distance from the trawl fishing gear to the ship. As a result, a whole fishing operation process is time-consuming, laborious, which certainly affects effective trawling time and capture yield. Regarding fishing operation mode using beam trawl, as an operation state of a netting gear is mainly controlled by a length of the beam prepositioned at the front end of a mouth, horizontal expansion of the mouth is more stable, not easily deformed. Compared with the otter trawl, a connection between a ship and a net only involves a single warp, a beam, a floating ball and a sinker, together with an upper line, a lateral line and a lower line and the like, so that a working state of a trawl fishing gear is ensured, a distance from the trawl net to the ship is relatively short, facilitating rapid operation of casting and hauling of the net and quick adjustment of net position. Furthermore, regarding fishing operation mode using the beam trawl, fishing operation may be performed only through a single warp and if a supporting rod is provided at two sides of a ship simultaneously and a traction point for a warp is also provided, trawl fishing operation can be carried out at each of two sides of the ship, thereby improving efficiency of fishing by multiple. It is the most efficient operation mode for fishing Antarctic Krill.

China's Antarctic Krill fishery has been developed for nearly 10 years, mainly in an operation mode of an otter trawl. Although China ranks the second in the world in the capture yield and scale of fishing for Antarctic Krill, compared with Norway which possesses a continuous pump suction fishing technology, there is still an significant gap, and a single ship fishing efficiency and capture yield of our country is only ½ and ⅓ thereof. The main reason lies in differences of fishing operation.

### SUMMARY

In order to solve the problem of low fishing efficiency and unstable operation performance of Antarctic Krill otter trawl in the existing technology, the present disclosure provides an Antarctic Krill beam trawl fishing gear structure in a gravity expandable mode, with a function of natural vertical expansion of a mouth.

The present disclosure provides a self-expandable mouth structure of an Antarctic Krill trawl with centralized sinker, the trawl includes a netting gear. The netting gear includes a beam, an upper border rope, a lower border rope, lateral lines, a cover net, a flank net and a body net. A length of the beam is 18 to 20 meters, a diameter of the beam is within a range from 250 to 300 millimeters, and the beam enables the mouth to expand horizontally. Sinkers 11 are provided at two sides of a belly net at a front end of a mouth of the body net. A component force by the sinker is transmitted through the lateral lines and the sewing edge so as to enable the lower border rope to be in a tensioned state due to the transmitted force.

A weight of the sinker at one side is 4 tons, and a vertical line perpendicular to a back net through a force bearing point of the lower border rope forms an angle of 2.1 degrees with respect to a vertical line perpendicular to a belly net through the force bearing point of the lower border rope, so that a 500 kg transverse tension force can be generated at the lower border rope; and the mouth of the body net forms an angle of 36.0 degrees with respect to the lateral lines, so that a forward stretching force of 2900 kg can be generated.

The body net includes a back net, a lateral net and a belly net. A taper ratio of the back net and the lateral net are 2-1, and taper ratios of the belly net from the first section to the third section of the body net along a length direction of the body net are 3-1, 3-1 and 3-1 respectively.

According to the trawl mouth structure of the present disclosure, assuming that a horizontal hanging ratio is 0.3, the weight of the sinker at one side is 4 tons per side, and the angle between the vertical line perpendicular to the back net through the force bearing point and the vertical line perpendicular to the belly net through the force bearing point is 2.1 degrees, 500 kg transverse tension force can be generated at the lower border rope. The lateral lines form an angle of 36.0 degrees with respect to the mouth of the body net, forward tension force of 2900 kg per side can be generated. As a result, no footrope is required to control vertical expansion of the netting gear mouth through a weight of the footrope, the mouth of the netting gear is always in a natural expansion state, facilitating shape stability of the trawl mouth in an operation state and high and stable yield during the process of trawling operation. According to the present disclosure, inflow surfaces consisted of the back net, the lateral net and the belly net from the first to three sections in the front of the net body exhibits a structure of inverted right trapezoid, and by means of a special structure of the trawl mouth and a centralized sinker configuration, the trawl mouth can be maintained in a horizontal expansion via buoyancy provided by a beam, without a float line of an upper line and a footrope of a lower line. Through sinkers centralizedly configured at two connecting points between the lateral net and the belly net positioned at the trawl mouth, the present disclosure can realize the natural vertical expansion of the trawl mouth, by using a special structure of the trawl mouth and a component force generated by sinker to cause the left and right tension forces at a abdomen portion of the trawl mouth and the forward tension force at a side portion of trawl mouth. Compared with an otter trawl, a connection between a ship and a trawl can be obtained only by providing a single warp, a beam, a floating ball and a sinker, and further combined with an upper line, a lateral line and a lower line, a working state of the trawl fishing gear can be ensured. A distance between a trawl netting gear and a ship is relatively short, which is convenient for quick operation of casting and hauling the trawl and quick adjustment of the trawl position. By changing a netting gear structure of an otter trawl and a configuration method of floating and sinking force, the present disclosure reduces influences on trawling operation caused by operation environments such as wind, wave, current and trawl speed, improves stability of trawling operation, simplifies operation system configuration and operation process, realizes stable expansion of the trawl mouth, ensures a sea sweeping area of the trawl mouth, increases water filtering volume of the netting gear and improves fishing efficiency. It can meet demands of efficiently fishing Antarctic Krill.

In some embodiments, the body net has ten sections, the inflow surfaces of the netting gear from the first section to the third section of the body net adopt an inverted right trapezoidal structure. Lengths of two waist sides of the first section of the body net are equal to the upper side length of the first section of the body net. The lower side length of the first section of the body net is less than the upper side length of the first section of the body net. Netting from the fourth section to the tenth section of the body net have a four piece symmetrical structure, and inflow surfaces thereof present a square structure.

In some embodiments, a mesh size of the netting of the cover net and a mesh size of the netting of the flank net are both 200 millimeters, and the cover net is composed of four equilateral triangular nets and a piece of rectangular netting.

In some embodiments, a taper ratio 1-1 is adopted for the netting of the equilateral triangular net, and a taper ratio 3-13 is adopted for the netting of the flank net.

In some embodiments, a length of a netting of each section of the cover net in a tensioned state is 8 meters, a total length of two sections of the cover net is 16 meters, and a length of the netting of each section of the body net in a tensioned state is 8 meters, and the total length of all sections of the body net is 80 meters.

In some embodiments, net pieces from the fourth section of the body net to the tenth section of the body net have a four piece symmetrical structure, and taper ratios of the nettings from the fourth section of the body net to the tenth section of the body net are 3-1, 3-1, 4-1, 4-1, 4-1, 5-1 and 5-1, respectively.

The other sections of the body net after the fourth section present a structure of four symmetrical pieces. An outer net and an inner net adopt nettings with the same specification, facilitating to exchange between netting at inner side and netting at outer side, at different locations of the netting gear according to the force and wear of the netting gear during the use, so as to prolong service life of the netting gear.

In some embodiments, a circumference of the mouth at the front end of the body net with the netting tensioned is 248 meters, and the circumference of a mouth at a back end of the body net with the netting tensioned is 44.8 meters.

In some embodiments, width mesh numbers along both waist sides and along the upper side of the first section of the body net is 320 mesh, a width mesh number along the lower side of the first section of the body net is 280 mesh, which is 87.5% of that along the other sides of the first section of the body net. A width mesh number along the lower side of the second section of the body net is 90.7% of that along the other sides of the second section of the body net. A width mesh number along the lower side of the third section of the body net is 95.0% of that along the other sides of the third section of the body net.

In the embodiments, the body net is provided with an inner net from the first section thereof, the inner net and the outer net of the body net adopt a netting specification with mesh size of 15 millimeters and a netting specification with mesh size of 200 millimeters respectively, allowing the outer and inner nets to be manufactured more conveniently to facilitate nettings to be exchanged, and improve utilization rate of nettings.

In some embodiments, the netting gear is a netting gear in a four-piece structure made of polyethylene.

The present disclosure has the following advantages of: simplifying netting structure and processing technology of a netting gear, saving labor cost and improving processing efficiency; optimizing body net structure of a trawl netting gear; realizing self-expandable function of the mouth through centralized sinker configuration; changing a configuration method of floating and sinking force, simplifying structures of an upper line and a lower line; improving expansion performance of the netting gear; allowing Antarctic Krill trawl to be in a good working condition all the time; providing a fishing gear for continuously fishing Antarctic Krill via pumping and improving fishing efficiency of Antarctic Krill.

### BRIEFT DESCRIPTION OF THE DRAWINGS

FIG. 1 is a schematic diagram of an expanded netting of an expandable Antarctic Krill beam trawl fishing gear.

FIG. 2 is a front view of a mouth of the expandable Antarctic Krill beam trawl.

FIG. 3 is a side view of the mouth of the expandable Antarctic Krill beam trawl.

Reference numbers and components involved in the accompanying drawings are as follows:

1 cover net, 2 flank net, 3 body net, 4 back net, 5 lateral net, 6 belly net, 7 beam, 8 floating ball, 9 lateral line, 10 sewing edge, 11 sinker, 12 lower border rope, 13 upper border rope

### DETAILED DESCRIPTION OF THE EMBODIMENTS

The present disclosure will be further described in combination with the embodiments and referring to the accompany drawings.

### Embodiment 1

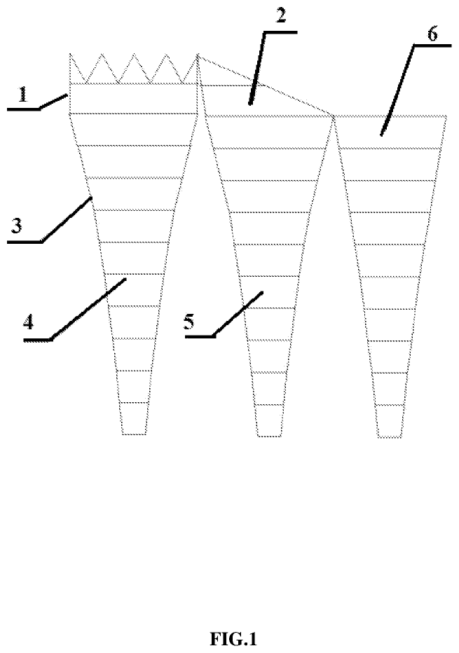

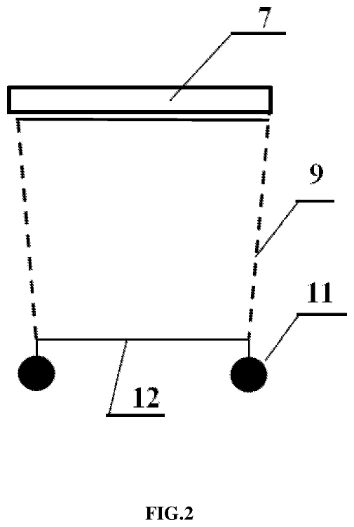

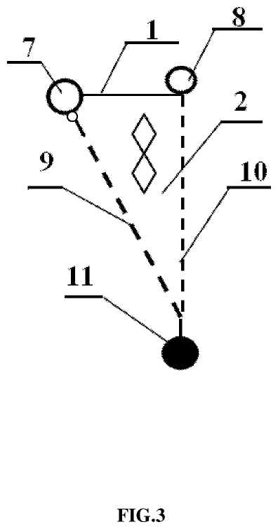

Referring to FIG. 1-FIG. 3, the present disclosure provides a self-expandable mouth structure of an Antarctic Krill trawl with centralized sinker, the trawl includes a netting gear. The netting gear includes a beam 7, an upper border rope, a lower border rope, lateral lines 9, a cover net 1, a flank net 2 and a body net 3. A length of the beam is 18 to 20 meters, a diameter of the beam is within a range from 250 to 300 millimeters, and the beam enables the mouth to expand horizontally. Sinkers 11 are provided at two sides of the belly net at a front end of a mouth of the body net. A component force by the sinker is transmitted through the lateral lines and the sewing edge 10 so as to enable the lower border rope to be in a tensioned state due to the transmitted force. A weight of the sinker at one side is 4 tons, and a vertical line perpendicular to a back net through a force bearing point of the lower border rope forms an angle of 2.1 degrees with respect to a vertical line perpendicular to a belly net through the force bearing point of the lower border rope, so that a 500 kg transverse tension force can be generated at the lower border rope; and the mouth of the body net forms an angle of 36.0 degrees with respect to the lateral lines, so that a forward stretching force of 2900 kg can be generated. The body net includes a back net 4, a lateral net 5 and a belly net 6. A taper ratio of the back net and the lateral net are 2-1, and taper ratios of the belly net from the first section to the third section of the body net along a length direction of the body net are 3-1, 3-1 and 3-1 respectively.

According to the trawl mouth structure of the present disclosure, assuming that a horizontal hanging ratio is 0.3, the weight of the sinker at one side is 4 tons per side, and the angle between the vertical line perpendicular to the back net through the force bearing point and the vertical line perpendicular to the belly net through the force bearing point is 2.1 degrees, 500 kg transverse tension force can be generated at the lower border rope. The lateral lines form an angle of 36.0 degrees with respect to the mouth of the body net, forward tension force of 2900 kg per side can be generated. As a result, no footrope is required to control vertical expansion of the netting gear mouth through a weight of the footrope, the mouth of the netting gear is always in a natural expansion state, facilitating shape stability of the trawl mouth in an operation state and high and stable yield during the process of trawling operation. According to the present disclosure, inflow surfaces consisted of the back net, the lateral net and the belly net from the first to three sections in the front of the net body exhibits a structure of inverted right trapezoid, and by means of a special structure of the trawl mouth and a centralized sinker configuration, the trawl mouth can be maintained in a horizontal expansion via buoyancy provided by a beam, without a float line of an upper line and a footrope of a lower border rope. Through sinkers centralizedly configured at two connecting points between the lateral net and the belly net positioned at the trawl mouth, the present disclosure can realize the natural vertical expansion of the trawl mouth, by using a special structure of the trawl mouth and a component force generated by sinker to cause the left and right tension forces at a abdomen portion of the trawl mouth and the forward tension force at a side portion of trawl mouth. Compared with an otter trawl, a connection between a ship and a trawl can be obtained only by providing a single warp, a beam, a floating ball 8 and a sinker, and further combined with an upper line, a lateral line and a lower line, a working state of the trawl fishing gear can be ensured. A distance between a trawl netting gear and a ship is relatively short, which is convenient for quick operation of casting and hauling the trawl and quick adjustment of the trawl position. By changing a netting gear structure of an otter trawl and a configuration method of floating and sinking force, the present disclosure reduces influences on trawling operation caused by operation environments such as wind, wave, current and trawl speed, improves stability of trawling operation, simplifies operation system configuration and operation process, realizes stable expansion of the trawl mouth, ensures a sea sweeping area of the trawl mouth, increases water filtering volume of the netting gear and improves fishing efficiency. It can meet demands of efficiently fishing Antarctic Krill.

In some embodiments, the body net has ten sections, the inflow surfaces of the netting gear from the first section to the third section of the body net adopt an inverted right trapezoidal structure. Lengths of two waist sides of the first section of the body net are equal to the upper side length of the first section of the body net. The lower side length of the first section of the body net is less than the upper side length of the first section of the body net. Netting from the fourth section to the tenth section of the body net have a four piece symmetrical structure, and inflow surfaces thereof present a square structure.

In some embodiments, a mesh size of the netting of the cover net and a mesh size of the netting of the flank net are both 200 millimeters, and the cover net is composed of four equilateral triangular nets and a piece of rectangular netting.

In some embodiments, a taper ratio 1-1 is adopted for the netting of the equilateral triangular net, and a taper ratio 3-13 is adopted for the netting of the flank net.

In some embodiments, a length of a netting of each section of the cover net in a tensioned state is 8 meters, a total length of two sections of the cover net is 16 meters, and a length of the netting of each section of the body net in a tensioned state is 8 meters, and the total length of all sections of the body net is 80 meters.

In some embodiments, net pieces from the fourth section of the body net to the tenth section of the body net have a four piece symmetrical structure, and taper ratios of the nettings from the fourth section of the body net to the tenth section of the body net are 3-1, 3-1, 4-1, 4-1, 4-1, 5-1 and 5-1, respectively. The other sections of the body net after the fourth section present a structure of four symmetrical pieces. An outer net and an inner net adopt nettings with the same specification, facilitating to exchange between netting at inner side and netting at outer side, at different locations of the netting gear according to the force and wear of the netting gear during the use, so as to prolong service life of the netting gear.

In some embodiments, a circumference of the mouth at the front end of the body net with the netting tensioned is 248 meters, and the circumference of a mouth at a back end of the body net with the netting tensioned is 44.8 meters.

In some embodiments, width mesh numbers along both waist sides and along the upper side of the first section of the body net is 320 mesh, a width mesh number along the lower side of the first section of the body net is 280 mesh, which is 87.5% of that along the other sides of the first section of the body net. A width mesh number along the lower side of the second section of the body net is 90.7% of that along the other sides of the second section of the body net. A width mesh number along the lower side of the third section of the body net is 95.0% of that along the other sides of the third section of the body net.

In the embodiments, the body net is provided with an inner net from the first section thereof, the inner net and the outer net of the body net adopt a netting specification with mesh size of 15 millimeters and a netting specification with mesh size of 200 millimeters respectively, allowing the outer and inner nets to be manufactured more conveniently to facilitate nettings to be exchanged, and improve utilization rate of nettings.

In some embodiments, the netting gear is a netting gear in a four-piece structure made of polyethylene.

The present disclosure has the following advantages of: simplifying netting structure and processing technology of a netting gear, saving labor cost and improving processing efficiency; optimizing body net structure of a trawl netting gear; realizing self-expandable function of the mouth through centralized sinker configuration; changing a configuration method of floating and sinking force, simplifying structures of an upper line and a lower line; improving expansion performance of the netting gear; allowing Antarctic Krill trawl to be in a good working condition all the time; providing a fishing gear for continuously fishing Antarctic Krill via pumping and improving fishing efficiency of Antarctic Krill.

The above is only some embodiment of the present disclosure. It should be noted that, for a general skilled person in the present technical field, some improvements and supplements can be made without departing from principles of the present disclosure, which should also be fallen within protection scope of the present disclosure.

1. An Antarctic Krill trawl with a centralized sinker and a self-expandable mouth structure, the trawl comprising a netting gear, the netting gear comprises a beam, an upper border rope, a lower border rope, a lateral line, a cover net, a flank net and a body net, wherein a length of the beam is 18 to 20 meters, a diameter of the beam is within a range from 250 to 300 millimeters, the beam enables the mouth to be expanded horizontally, a sinker is provided at each of two sides of a belly net at a front end of a first mouth of the body net, a component force of a sinking force by the sinker is transmitted through the lateral line and a sewing edge so as to cause the lower border rope in a tensioning state due to the transmitted force;
a weight of the sinker at one side is 4 tons; a vertical line perpendicular to a back net through a force bearing point of the lower border rope forms an angle of about 2.1 degrees with respect to a vertical line perpendicular to a belly net through the force bearing point of the lower boarder rope to generate 500 kg transverse tension force at the lower border rope, and the mouth of the body net forms an angle of 36.0 degrees with respect to the lateral line, to generate 2900 kg forward tension force; and
the body net comprises a back net, a lateral net and a belly net, taper ratios of the back net and the lateral net are 2-1, taper ratios of the belly net from a first section to a third section of the body net along a length direction of the body net are 3-1, 3-1 and 3-1 respectively.

2. The Antarctic Krill trawl with a centralized sinker and a self-expandable mouth structure according to claim 1, wherein the net body has ten sections, inflow surfaces of the netting gear at the first section to the third section of the body net all adopt an inverted right trapezoidal structure, and lengths of two waist sides of the first section of the body net are equal to a length of an upper side of the first section of the body net, a length of a lower side of the first section of the body net is less than the length of the upper side of the first section of the body net; nettings from a fourth section to a tenth section of the body net have a four piece symmetrical structure, and inflow surfaces thereof are square structures.

3. The Antarctic Krill trawl with a centralized sinker and a self-expandable mouth structure according to claim 1, wherein a mesh size of the cover net and of a netting of the flank net are 200 millimeters, and the cover net comprises four equilateral triangular nets and a piece of rectangular netting.

4. The Antarctic Krill trawl with a centralized sinker and a self-expandable mouth structure according to claim 3, wherein a taper ratio 1 to 1 is adopted for a netting of the equilateral triangular net; a taper ratio 3 to 13 is adopted for a netting of the flank net.

5. The Antarctic Krill trawl with a centralized sinker and a self-expandable mouth structure according to claim 1, wherein a length of a netting of each section of the cover net in tensioned state is 8 meters, a total length of two sections of the cover net is 16 meters, a length of a netting of each section of the body net in tensioned state is 8 meters, a total length of all sections of the body net is 80 meters.

6. The Antarctic Krill trawl with a centralized sinker and a self-expandable mouth structure according to claim 1, wherein net pieces from the fourth section to the tenth section of the body net have a four piece symmetrical structure, and taper ratios of the netting of the fourth section to the tenth section of the body net are 3-1, 3-1, 4-1, 4-1, 4-1, 5-1 and 5-1, respectively.

7. The Antarctic Krill trawl with a centralized sinker and a self-expandable mouth structure according to claim 1, wherein a circumference of the first mouth at the front end of the body net with a netting around the first mouth tensioned is 248 meters, and a circumference of a second mouth at a back end of the body net with a netting around the second mouth tensioned is 44.8 meters.

8. The Antarctic Krill trawl with a centralized sinker and a self-expandable mouth structure according to claim 1, wherein width mesh numbers along both waist sides and along an upper side in the first section of the body net are 320 mesh, a width mesh number along a lower side in the first section of the body net is 280 mesh, which is 87.5% of that along other sides in the first section of the body net, a width mesh number along a lower side in the second section of the body net is 90.7% of that along other sides in the second section of the body net, a width mesh number along a lower side in the third section of the body net is 95.0% of that along other sides in the third section of the body net.

9. The Antarctic Krill trawl with a centralized sinker and a self-expandable mouth structure according to claim 1, wherein the body net is provided with an inner net starting from the first section of the body net, the inner net and an outer net of the body net adopt a netting specification with mesh sizes of 15 mm and a netting specification with mesh sizes of 200 mm respectively.
